(19) United States
(12) Patent Application Publication
(10) Pub. No.: US 2025/0374173 A1
(43) Pub. Date: Dec. 4, 2025

(54) METHOD AND APPARATUS FOR ACCESSING HOSTING NETWORK, DEVICE, AND STORAGE MEDIUM

(71) Applicant: Beijing Xiaomi Mobile Software Co., Ltd., Beijing (CN)

(72) Inventor: Jianning LIU, Beijing (CN)

(73) Assignee: Beijing Xiaomi Mobile Software Co., Ltd., Beijing (CN)

(21) Appl. No.: 18/852,116

(22) PCT Filed: Mar. 29, 2022
(86) PCT No.: PCT/CN2022/083805

§ 371 Date: Sep. 27, 2024

(51) Int. Cl. H04W 48/18; H04W 64/00

(52) U.S. Cl. CPC H04W 48/18; H04W 64/00

(57) ABSTRACT

A method and apparatus for accessing a hosting network, a device, and a storage medium, relating to the field of wireless communications. The method is applied to a terminal device and comprises: controlling a network selection process in response to determining that a first hosting network is accessed. The method, the apparatus, the device and the storage medium can prevent the terminal device from being automatically switched to a high-priority network after accessing a hosting network, thereby avoiding service interruption of the hosting network.

### CROSS REFERENCE TO RELATED APPLICATIONS

This application is a US National Phase of a PCT Application No. PCT/CN2022/083805 filed on Mar. 29, 2022, the entire contents of which are incorporated herein by reference in their entireties.

### TECHNICAL FIELD

The present disclosure relates to the field of wireless communication, and in particular to a method and apparatus for accessing a hosting network, a device, and a storage medium.

### BACKGROUND

Vertical industries (non-public networks) are important deployment scenarios for 5G commercialization. For example, a concert venue can set up a Stand-alone Non-Public Network (SNPN) to provide more professional and high-quality music/video services. And a Public Land Mobile Network (PLMN) can provide ordinary data, voice and other services with wide coverage. Therefore, a user can choose an appropriate network to obtain a corresponding service according to needs.

When a terminal device is in an automatic network selection mode, the terminal automatically selects networks based on a priority order of the networks. When a terminal device temporarily accesses a hosting network, such as a SNPN of a music venue, the terminal device periodically monitors network signals. When a network signal of a higher-priority network is detected, the terminal device will automatically choose to access the higher-priority network, causing interruption of the service in the hosting network.

### SUMMARY

The embodiments of the present disclosure provide a method and an apparatus for accessing a hosting network, a device, and a storage medium, which can prevent the terminal device from being automatically switched to a high-priority network after accessing a hosting network, thereby avoiding service interruption of the hosting network. The technical solution is as follows.

According to an aspect of the present disclosure, a method for accessing a hosting network is provided, where the method is performed by a terminal device, and includes:
in response to determining that a first hosting network is accessed, controlling a network selection process.

According to an aspect of the present disclosure, a method for accessing a hosting network, where the method is performed by a first hosting network device, and includes:
providing an access service based on indication information to a terminal device, where the indication information is configured to control a network selection process of the terminal device in response to determining that the terminal device accesses a first hosting network corresponding to the first hosting network device.

According to an aspect of the present disclosure, an apparatus for accessing a hosting network, and includes:
a controlling module, configured to, in response to determining that a first hosting network is accessed, control a network selection process.

According to an aspect of the present disclosure, an apparatus for accessing a hosting network, and includes:
an accessing module, configured to provide an access service based on indication information to a terminal device, where the indication information is configured to control a network selection process of the terminal device in response to determining that the terminal device accesses a first hosting network corresponding to the first hosting network device.

According to an aspect of the present disclosure, a terminal device is provided, and includes: one or more processors; where
the one or more processors are configured to, in response to determining that a first hosting network is accessed, control a network selection process.

According to an aspect of the present disclosure, a network device is provided, and includes: one or more processors; where
the one or more processors are configured to provide an access service based on indication information to a terminal device, where the indication information is configured to control a network selection process of the terminal device in response to determining that the terminal device accesses a first hosting network corresponding to the first hosting network device.

According to an aspect of the present disclosure, a computer-readable storage medium is provided, where the computer-readable storage medium stores executable instructions, and the executable instructions are loaded and executed by one or more processors to implement the method for accessing a hosting network according to the aspect described above.

According to an aspect of the embodiments of the present disclosure, a chip is provided, including programmable logic circuits and/or program instructions for implementing the method for accessing a hosting network described above in response to determining that the chip is run on a computer device.

According to an aspect of the present disclosure, a computer program product is provided, where in response to determining that run on a processor of a computer device, causes the computer device to perform the method for accessing a hosting network described above.

The technical solutions provided in the embodiments of the present disclosure includes at least the following beneficial effects.

The network selection process is controlled after the hosting network is accessed. For example, the terminal device does not perform network selection after the hosting network is accessed, or the terminal does not perform network selection for a period after the hosting network is accessed. The terminal device can control the network selection process when accessing the hosting network, which can avoid automatic access to higher priority networks and ensure the normal operation of a service in the hosting network.

### BRIEF DESCRIPTION OF DRAWINGS

In order to more clearly illustrate the technical solutions according to the embodiments of the present disclosure, drawings that need to be used in the description of the embodiments will be briefly introduced below. The drawings in the following description only relate to some embodiments of the present disclosure. For those skilled in the art, other drawings can also be obtained based on these drawings without creative effort.

FIG. 1 is a schematic diagram of a system architecture provided in an embodiment of the present disclosure.

FIG. 2 is a flowchart of a method for accessing a hosting network provided in an embodiment of the present disclosure.

FIG. 3 is a flowchart of a method for accessing a hosting network provided in an embodiment of the present disclosure.

FIG. 4 is a flowchart of a method for accessing a hosting network provided in an embodiment of the present disclosure.

FIG. 5 is a structural block diagram of an apparatus for accessing a hosting network provided in an embodiment of the present disclosure.

FIG. 6 is a structural block diagram of an apparatus for accessing a hosting network provided in an embodiment of the present disclosure.

FIG. 7 is a structural schematic diagram of a communication device provided in an embodiment of the present disclosure.

### DETAILED DESCRIPTION

In clarify purposes, technical solutions, and advantages of the embodiments of the present disclosure, further detailed descriptions of the embodiments of the present disclosure are provided below in conjunction with the accompanying drawings. Embodiments will be described in detail here with the examples thereof expressed in the drawings. When the following descriptions involve the drawings, like numerals in different drawings represent like or similar elements unless stated otherwise. Embodiments described in the illustrative examples below are not intended to represent all embodiments consistent with the present disclosure. Rather, they are merely embodiments of devices and methods consistent with some aspects of the present disclosure as recited in the appended claims. The network architecture and service scenario described in the embodiments of the present disclosure are intended to provide a clearer explanation of the technical solutions in the embodiments of the present disclosure, and does not constitute a limitation on the technical solutions provided in the embodiments of the present disclosure. As those skilled in the art know, with the evolution of the network architecture and the emergence of new service scenarios, the technical solutions provided in the embodiments of the present disclosure are also applicable to similar technical problems. The term used in the present disclosure is for the purpose of describing particular examples only and is not intended to limit the present disclosure. As used in the present disclosure and the appended claims, the singular forms “a”, “an” and “the” are intended to include the plural forms as well, unless the context clearly indicates otherwise. It should also be understood that the term “and/or” as used herein refers to and includes any and all possible combinations of one or more of the associated listed items.

It should be understood that although the terms first, second, etc. may be used in the present disclosure to describe various information, such information should not be limited to these terms. These terms are only used to distinguish one category of information from another. For example, without departing from the scope of the present disclosure, a first parameter may be referred as a second parameter; and similarly, a second parameter may also be referred as a first parameter. Depending on the context, the word “if” as used herein can be interpreted as “at the time of”, “when” or “in response to determining”.

It should be noted that information (including but not limited to user equipment information, user personal information, etc.), data (including but not limited to data used for analysis, stored data, displayed data, etc.), and signals involved in the present disclosure are all authorized by users or fully authorized by all parties, and the collection, use, and processing of relevant data comply with relevant laws, regulations, and standards of relevant countries and regions.

Public Land Mobile Network (PLMN) is a network established and operated by the government or operators approved by the government for the purpose of providing land mobile communication services to the public.

At present, PLMN=Mobile Country Code (MCC)+Mobile Network Code (MNC). For example, 460 is for China, 00 is for manufacturer A, and 01 is for manufacturer B, and then the PLMN of manufacturer A in China is 46000, and the PLMN of manufacturer B in China is 46001.

For example, a terminal device maintains different types of centralized PLMN lists, with at least one PLMN in each PLMN list.

PLMNs can include the following types (1) to (5).

(1) Registered Public Land Mobile Network (RPLMN): the RPLMN is the PLMN registered by the terminal device before the last shutdown or off network.

(2) Home Public Land Mobile Network (HPLMN): the HPLMN is the PLMN to which the user corresponding to the terminal device belongs.

If there is a file EF_{EHPLMN} in a Universal Subscriber Identity Mobile (USIM) card and the file EF_{EHPLMN} is not empty, the HPLMN is the PLMN in the file. If the file does not exist in the USIM card, or if the file exists in the USIM card but the list in the file is empty, HPLMN is MCC obtained from an International Mobile Subscriber Identification number (IMSI) plus MNC obtained from the IMSI.

(3) User Public Land Mobile Network (UPLMN): the UPLMN is a parameter that is stored on the Subscriber Identity Module (SIM) card and related to the selection of PLMNs. The UPLMN is the PLMN selected by the terminal device when the user manually selects a network.

(4) Operator Controlled Public Land Mobile Network (OPLMN): the OPLMN is a parameter that is stored on the SIM card and related to the selection of PLMNs. Mainly, when the operator performs configuring on the SIM card, a PLMN of an operator that has signed a roaming agreement with the operator is written as an OPLMN into the SIM card, as a recommendation for network selection for the user during roaming.

(5) Visited PLMN (VPLMN): the VPLMN is a PLMN used for a terminal device to access. The PLMN and MNC/MCC of the IMSI stored in the SIM card are not exactly the same. When the mobile terminal device loses coverage, a VPLMN will be selected.

For example, different types of PLMNs have different priorities, and the priority order when a terminal selects PLMNs is RPLMN, HPLMN, UPLMN, OPLMN, and other PLMNs from high to low.

In the 5G network, a Non-Public network (NPN) is defined. The NPN is used for a private entity (such as an enterprise) and can be deployed using both virtual and physical devices.

5G non-public networks are divided into Stand-alone Non-Public Network (SNPN) and Public Network Integrated Non-Public Network (PNI-NPN). The PNI-NPN mode, also known as “public network for private use (use for vertical industry or private network)”, is divided into “fully shared with the public network” and “partially shared with the public network” according to the degree of sharing with the public network. That is, the NPN can be deployed as a completely independent network, hosted by a PLMN, or as a part of a PLMN. A completely independently deployed NPN is called Stand-alone Non-Public Network (SNPN), and an NPN hosted by a PLMN or provided as a part of a PLMN is called Public Network Integrated Non-Public Network (PNI-NPN).

The PNI-NPN has at least two implementation methods. In the first implementation method, the PNI-NPN is implemented by specifying a specific Data Network Name (DNN). In the second implementation, independent network resources are partitioned for NPN on the PLMN by slicing.

Referring to FIG. 1, FIG. 1 is a schematic diagram of a system architecture provided in an embodiment of the present disclosure. The communication system may include a network device 12 and a terminal device 14.

There may be multiple network devices 12, and different network devices are used to access different networks (such as NPN or PLMN). The network device 12 can be a base station. The base station is a device deployed in an access network to provide wireless communication functionality for the terminal device. The base station can include various forms of macro base stations, micro base stations, relay stations, access points, and so on. In systems using different wireless access technologies, the names of devices with base-station functionality may vary. For example, in LTE systems, they are referred to as eNodeBs or eNBs, and in 5GNR-U (5G New Radio Unlicensed) systems, they are called gNodeBs or gNBs. With the evolution of communication technology, the description of “base station” may change. For the convenience of description in the embodiments of the present disclosure, the devices that provide wireless communication functionality for the terminal device 14 are collectively referred to as network devices.

The terminal device 14 may include various handheld devices, on vehicle devices, wearable devices, computing devices, or other processing devices connected to wireless modems with wireless communication capabilities, as well as various forms of user equipment, mobile stations (MSs), terminal devices, and so on. For ease of description, the devices mentioned above are collectively referred to as terminal devices. The network device 12 and the terminal device 14 communicate with each other through some air interface technology, such as the Uu interface.

The technical solutions of the embodiments of the present disclosure can be applied to various communication systems, such as Global System of Mobile Communication (GSM) system, Code Division Multiple Access (CDMA) system, Wideband Code Division Multiple Access (WCDMA) system, General Packet Radio Service (GPRS), Long Term Evolution (LTE) system, LTE Frequency Division Duplex (FDD) system, LTE Time Division Duplex (TDD) system, Advanced Long Term Evolution (LTE-A) system, New Radio (NR) system, and NR-system evolution system, LTE-based access to Unlicensed spectrum (LTE-U) system, NR-U system, Universal Mobile Telecommunication System (UMTS), Worldwide Interoperability for Microwave Access (WiMAX) communication systems, Wireless Local Area Networks (WLAN), Wireless Fidelity (WiFi), next-generation communication system, or other communication systems.

Generally, traditional communication systems support a limited number of connections and are easy to implement. However, with the development of communication technology, a mobile communication system will not only support traditional communication, but also support Device to Device (D2D) communication, Machine to Machine (M2M) communication, Machine Type Communication (MTC), Vehicle to Vehicle (V2V) communication, and Vehicle to Everything (V2X) system. The embodiments of the present disclosure can also be applied to these communication systems.

The communication system shown in FIG. 1 is used to provide network access information to a terminal device for accessing a first network. The first network can be a 3GPP network, such as SNPN or PLMN. Alternatively, the first network can be a non-3GPP network, which is not limited.

In the embodiments of the present disclosure, the terminal includes a hardware layer, an operating system layer running on the hardware layer, and an application layer running on the operating system layer. The hardware layer includes hardwares such as the Central Processing Unit (CPU), Memory Management Unit (MMU), and memory (also known as main memory). The operating system can be any one or more computer operating systems that implement service processing through processes, such as Linux operating system, Unix operating system, Android operating system, iOS operating system, or windows operating system. The application layer includes browsers, contacts, word processing software, instant messaging software, and other applications. Moreover, the specific structure of the executing entity of the method provided in the embodiments of the present disclosure is not particularly limited, as long as the executing entity can implement communications according to the method provided in the embodiments of the present disclosure by running a program that records the code according to the method provided in the embodiments of the present disclosure.

In addition, various aspects or features of the present disclosure may be implemented as methods, apparatuses, or products using standard programming and/or engineering techniques. For example, the computer-readable medium may include, but is not limited to, a magnetic storage device (such as a hard disk, a floppy disk, or a magnetic tape), an optical disk (such as a Compact Disc (CD), or a Digital Versatile Disc (DVD), etc.), a smart card, or a flash memory device (such as an Erasable Programmable Read-Only Memory (EPROM), a card, a stick, or a key drive, etc.). In addition, the storage medium described herein may represent one or more devices and/or other machine-readable media used for storing information. The term “machine-readable medium” may include, but is not limited to, a wireless channel and various other media capable of storing, containing, and/or carrying instructions and/or data.

It can be understood that a terminal in the embodiments of the present disclosure can be deployed on land (including indoor or outdoor), handheld or vehicle mounted; or the terminal can be deployed on the water surface; or the terminal can be deployed on airplanes, balloons, and satellites in the air. The embodiments of the present disclosure do not limit the application scenarios of wireless access network devices and terminals.

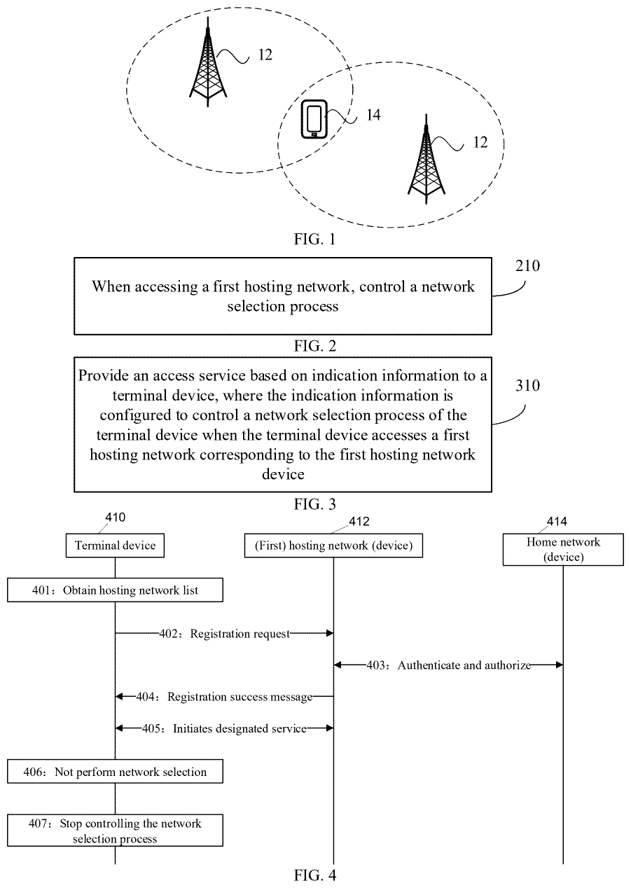

Referring to FIG. 2, FIG. 2 is a flowchart of a method for accessing a hosting network provided in an embodiment of the present disclosure. The method can be performed by a terminal device, which can be the terminal device in the communication system shown in FIG. 1. The method includes following step 210.

In step 210, in response to determining that accessing a first hosting network, a network selection process is controlled.

A hosting network, also known as a local network or an independent network, does not have a roaming agreement with the home network of the terminal device. The hosting network is different from a visited network, as the visited network has a roaming agreement with the home network. The hosting network can be an NPN (e.g., an SNPN or a PNI-NPN) or a PLMN. The home network can be an HPLMN, or an NPN.

The first hosting network corresponds to a new network selection manner (control manner), and the terminal device controls the network selection process based on the network selection manner corresponding to the first hosting network.

For example, the embodiments of the present disclosure provide eight optional network selection manners, and the terminal device can adopt any one of them to control the network selection process after the first hosting network is accessed.
1. in response to determining that the first hosting network is accessed, not monitoring network signals other than the signals of the first hosting network;
2. in response to determining that the terminal device is within the coverage area of the first hosting network, not monitoring network signals other than the signals of the first hosting network;
3. within the valid time of the first hosting network, not monitoring network signals other than the signals of the first hosting network;
4. within the valid time of the first hosting network and in response to determining that the terminal device is within the coverage area of the first hosting network, not monitoring network signals other than the signals of the first hosting network;
5. in response to determining that the first hosting network is accessed, monitoring network signals and not performing network selection;
6. in response to determining that the terminal device is within the coverage area of the first hosting network, monitoring network signals and not performing network selection;
7. within the valid time of the first hosting network, monitoring network signals and not performing network selection; and
8. within the valid time of the first hosting network and in response to determining that the terminal device is within the coverage area of the first hosting network, monitoring network signals and not performing network selection.

For example, the first hosting network may have indication information indicating controlling of the network selection process after the first hosting network is accessed. The indication information can be pre-configured, which can be configured by the home network of the terminal device, or transmitted to the terminal device by the first hosting network after the first hosting network is accessed.

The terminal device controls the network selection process based on the indication information. For example, the indication information may include at least one of the network identifier, priority, access technology, valid time, or control manner of the first hosting network. For example, when the first hosting network has the indication information, a preset control manner is used to control the network selection process, or a control manner indicated by the indication information is used to control the network selection process.

For example, the indication information may indicate that the first hosting network has the highest priority in the network selection process, and the terminal device will not switch to other networks after the first hosting network is accessed.

The indication information may be the indication information corresponding to the first hosting network. The indication information may also be a hosting network list, which includes the first hosting network.

When the indication information is a hosting network list, the terminal device accesses the first hosting network in the hosting network list, and the hosting network list is used to control the network selection process in response to determining that the hosting network in the hosting network list is accessed.

The hosting network list includes at least one hosting network, where the at least one hosting network includes a first hosting network. The first hosting network is only an example of one hosting network in the hosting network list, and the first hosting network can refer to any one hosting network in the hosting network list.

In the hosting network list, one hosting network corresponds to one set of parameters, a set of parameters for a hosting network at least includes the network identifier (NPN ID or PLMN ID) of the hosting network.

A set of parameters for a hosting network may further include an access technology and/or a valid time of the hosting network.

The access technology is used to indicate the access technology adopted by the hosting network, such as 4G/5G. For example, when the hosting network is a PLMN, the access technology is a necessary parameter, and when the hosting network is an NPN, the access technology is an optional parameter. For example, the access technology may further include a frequency band field. The frequency band field indicates an access frequency band for the network.

The valid time indicates the time for controlling the network selection process. For example, the network selection process is controlled according to a new network selection mechanism within the valid time after the hosting network is accessed. The valid time can also refer to the time for providing the service of the hosting network to the terminal device using the hosting network.

The hosting network list corresponds to a new network selection mechanism. In response to determining that a terminal device accesses a hosting network in the hosting network list, the terminal device controls the network selection process according to the new network selection mechanism. For example, the new network selection mechanism includes not performing new network selection after the hosting network is accessed. That is, the terminal device does not perform network selection after the hosting network in the hosting network list is accessed. For example, network selection includes network reselection.

The hosting network list has the highest priority, that is, during the process of network selection by the terminal device, the hosting network list has the highest priority, and the terminal device prioritize accessing a hosting network in the hosting network list. For example, the priority of the hosting network list is higher than the priority of HPLMN. For example, the priority of the hosting network list is higher than the priorities of RPLMN, HPLMN, UPLMN and OPLMN.

That is, the embodiments of the present disclosure define a new network selection mechanism, where a special network selection list (hosting network list) is stored locally on the terminal device. When the terminal device performs a service on the hosting network in the hosting network list, the terminal device will not perform new network selection, such as periodically selecting PLMN/SNPN with higher priority.

The highest priority hosting network list, includes:
NPN ID(s) or PLMN ID(s) (at least one NPN identifier, or at least one PLMN identifier),
Access technology, and
Valid time.

In summary, in the method provided in this embodiment, the network selection process is controlled after the hosting network is accessed. For example, the terminal device does not perform network selection after the hosting network is accessed, or the terminal does not perform network selection for a period after the hosting network is accessed. The terminal device can control the network selection process when accessing the hosting network, which can avoid automatic access to higher priority networks and ensure the normal operation of a service in the hosting network.

Referring to FIG. 3, FIG. 3 is a flowchart of a method for accessing a hosting network provided in an embodiment of the present disclosure. The method can be performed by a first hosting network device. The first hosting network device can be a network device in the communication system shown in FIG. 1. The method includes following step 310.

In step 310, an access service is provided based on indication information to a terminal device, where the indication information is configured to control a network selection process of the terminal device in response to determining that the terminal device accesses a first hosting network corresponding to the first hosting network device.

For example, when the indication information is indication information corresponding to the first hosting network, in an embodiment, the first hosting network device transmits the indication information to the terminal device, and the terminal device receives the indication information and controls the network selection process based on the indication information. In an embodiment, the indication information is pre-configured in the terminal device. The terminal device reads the indication information and controls the network selection process based on the indication information. In an embodiment, the indication information is configured for the terminal device by the home network. The terminal device receives the indication information transmitted by the home network and controls the network selection process based on the indication information.

For example, when the indication information is a hosting network list, the first hosting network device provides the access service based on the hosting network list to the terminal device. The hosting network list includes the first hosting network of the first hosting network device, and the hosting network list is used to control the network selection process in response to determining that the terminal device accesses the hosting network in the hosting network list.

For example, the terminal device accesses the first hosting network in the hosting network list, and the first hosting network device provides the access service to the first hosting network for the terminal device.

In summary, in the method provided in this embodiment, the network selection process is controlled after the hosting network is accessed. For example, the terminal device does not perform network selection after the hosting network is accessed, or the terminal does not perform network selection for a period after the hosting network is accessed. The terminal device can control the network selection process when accessing the hosting network, which can avoid automatic access to higher priority networks and ensure the normal operation of a service in the hosting network.

For example, an embodiment of controlling a network selection process of the terminal device based on a hosting network list is provided.

Referring to FIG. 4, FIG. 4 is a flowchart of a method for accessing a hosting network provided in an embodiment of the present disclosure. The method can be performed by the terminal device and the network device in the communication system shown in FIG. 1, and the network device may include a first hosting network device 412 and a home network device 414. The method includes following steps 401 to 407.

In step 401, the terminal device 410 obtains the hosting network list.

For example, the hosting network list can be pre-configured in the terminal device. The terminal device reads the pre-configured hosting network list.

The hosting network list can also be configured by the home network of the terminal device, and the terminal device dynamically obtains the hosting network list from the home network. For example, the home network device transmits SoR signaling to the terminal device. The SoR signaling includes a hosting network list. The terminal device receives SoR signaling transmitted by the home network device.

In step 402, the terminal device transmits a registration request to the first hosting network device.

When the terminal device moves to the coverage area of the first hosting network and detects the network signal of the first hosting network in the hosting network list, the terminal device performs network selection and selects to access the first hosting network.

The registration request includes the terminal device identifier. For example, the registration request may also include the home network identifier of the terminal device.

In step 403, the first hosting network device authenticates and authorizes the home network device based on the registration request.

The first hosting network device transmits authentication and authorization requests to the home network of the terminal device based on the registration request, to complete the authentication and authorization.

In step 404, the first hosting network device transmits a registration success message to the terminal device.

The terminal device receives the registration success message transmitted by the first hosting network device and successfully accesses the first hosting network.

In step 405, the terminal device initiates a designated service with the first hosting network device.

The designated service is provided by the first hosting network.

In step 406, the terminal device does not perform network selection in response to determining that the first hosting network is accessed.

For example, the control network selection includes two situations.

Situation 1: the terminal device does not monitor network signals from networks other than the first hosting network. That is, the terminal device does not perform network signal monitoring for network selection.

Situation 2: the terminal device (periodically) monitors network signals, but ignores the monitoring results and does not perform network selection.

For example, when the parameters included in the hosting network list are different, various manners can be used to control the network selection process. Taking the parameter corresponding to the first hosting network in the hosting network list as an example:
1. when the network identifier of the first hosting network is included in the hosting network list:
manner (1): the terminal device can control the network selection process when the hosting network list includes the network identifier of the first hosting network;
manner (2): the terminal device can control the network selection process when the hosting network list includes the network identifier of the first hosting network and the terminal device is within the coverage area of the first hosting network.
2. when the valid time of the first hosting network is included in the hosting network list:
manner (3): the terminal device can control the network selection process when the hosting network list includes the network identifier of the first hosting network and within the valid time of the first hosting network;
manner (4): the terminal device can control the network selection process when the network identifier of the first hosting network is included in the hosting network list, within the valid time of the first hosting network, and in response to determining that the terminal device is within the coverage area of the first hosting network.

For example, by taking into account the two situations of controlling of the network selection process and the four manners mentioned above, a total of eight combination manners can be obtained.

For example, one combination manner is that the terminal device can periodically monitor network signals, but ignore the monitoring results and do not perform network selection, when the network identifier of the first hosting network is included in the hosting network list, within the valid time of the first hosting network, and in response to determining that the network device is within the coverage area of the first hosting network.

For example, the hosting network list may further include the control manner corresponding to each hosting network. For example, numbers from 0 to 8 can be used to correspond to 8 different control manners, to indicate which control manner the terminal device uses to control the network selection process after each hosting network is accessed.

For example, after the first hosting network is accessed, the terminal device will no longer perform new network selection within the valid time and coverage area of the first hosting network, or ignore the mechanism of network reselection. For example, when a terminal device detects other network signals, the terminal device skips network selection.

In step 407, the terminal device stops controlling the network selection process.

When the designated service is completed, the terminal device stops controlling the network selection process. For example, the terminal device cancels the highest priority of the first hosting network (such as deletion/deactivation indication information), and subsequently, the terminal device can periodically monitor the network signals of other networks and access the higher priority network when the terminal detects other networks with higher priority.

After the designated service is completed, if the terminal device needs to access back to the home network or other networks, the hosting network list needs to be closed or deleted to avoid the terminal device being unable to reconnect to other networks due to the highest priority of the hosting network list.

In an embodiment, the hosting network list includes the valid time corresponding to the first hosting network. The terminal device starts timing after the first hosting network is accessed. In response to determining that the valid time of the first hosting network expires (i.e., the timing exceeds the valid time), the first hosting network in the hosting network list is deleted, that is, deleting the information corresponding to the first hosting network from the hosting network list (such as network identifier, valid time, or access technology). Alternatively, the terminal device may delete the hosting network list in response to determining that the valid time of the first hosting network expires. Alternatively, the terminal device can deactivate the hosting network list in response to determining that the valid time of the first hosting network expires.

In an embodiment, after the designated service is completed, the terminal device may also delete the first hosting network from the hosting network list; or delete the hosting network list; or, deactivate the hosting network list.

In summary, the method provided in this embodiment, by adding a hosting network list, can indicate that the terminal device does not perform the network selection process after accessing the hosting network. For example, the terminal device does not perform network selection after accessing the hosting network in the hosting network list, or does not perform network selection for a period after accessing the hosting network in the hosting network list. If the terminal device accesses the hosting network based on the hosting network list, the terminal device can control the network selection process when accessing the hosting network, which can avoid the terminal device automatically accessing higher priority networks, and ensure the normal operation of a service in the hosting network.

It should be noted that those skilled in this field can combine the steps in any of the above embodiments to achieve a new embodiment, which will not be repeated here.

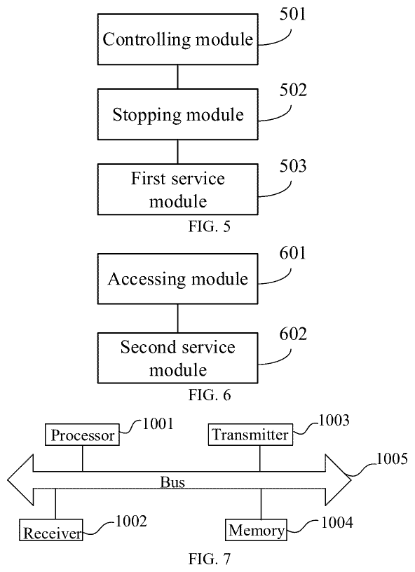

FIG. 5 is a structural block diagram of an apparatus for accessing a hosting network provided in an embodiment of the present disclosure. The apparatus can be implemented as a terminal device or as a part of a terminal device. The apparatus includes:

a controlling module 501, configured to, in response to determining that a first hosting network is accessed, control a network selection process.

In an embodiment, the controlling module 501 is configured to, in response to determining that the first hosting network is accessed and the terminal device is within a coverage area of the first hosting network, control the network selection process.

In an embodiment, the first hosting network has a corresponding valid time;
the controlling module 501 is configured to, in response to determining that the first hosting network is accessed, and within the valid time of the first hosting network, control the network selection process; or
the controlling module 501 is configured to, in response to determining that the first hosting network is accessed, within the valid time of the first hosting network, and in response to determining that the terminal device is within a coverage area of the first hosting network, control the network selection process.

In an embodiment, the terminal device stores a hosting network list, where the hosting network list includes the first hosting network, and the hosting network list is configured to control the network selection process in response to determining that a hosting network in the hosting network list is accessed.

In an embodiment, the hosting network list includes a network identifier of each of at least one hosting network, and the at least one hosting network includes the first hosting network.

In an embodiment, the controlling module 501 is configured to, in response to determining that the terminal device accesses the first hosting network and the hosting network list includes a network identifier of the first hosting network, control the network selection process; or
the controlling module 501 is configured to, in response to determining that the first hosting network is accessed, the hosting network list includes a network identifier of the first hosting network, and the terminal device is within a coverage area of the first hosting network, control the network selection process.

In an embodiment, the hosting network list further includes at least one of: a valid time for each of the at least one hosting network, or an access technology for each of the at least one hosting network.

In an embodiment, the hosting network list includes the valid time of the first hosting network;
the controlling module 501 is configured to, in response to determining that the first hosting network is accessed, and the hosting network list includes a network identifier of the first hosting network, and within the valid time of the first hosting network, control the network selection process; or
the controlling module 501 is configured to, in response to determining that the first hosting network is accessed, the hosting network list includes a network identifier of the first hosting network, and the terminal device is within a coverage area of the first hosting network, and within the valid time of the first hosting network, control the network selection process.

In an embodiment, the controlling module 501 is configured to, not monitor network signals other than a signal of the first hosting network; or
the controlling module 501 is configured to monitor network signals and not perform network selection.

In an embodiment, a network selection priority of the hosting network list is higher than network selection priorities of other network lists.

In an embodiment, the hosting network list is pre-configured;
the hosting network list is configured by a home network of the terminal device.

In an embodiment, the hosting network list includes the valid time of the first hosting network, and the apparatus further includes:
a stopping module 502, configured to, in response to determining that the valid time of the first hosting network expires, delete the first hosting network from the hosting network list;
a stopping module 502, configured to, in response to determining that the valid time of the first hosting network expires, delete the hosting network list; or
a stopping module 502, configured to, in response to determining that the valid time of the first hosting network expires, deactivate the hosting network list.

In an embodiment, the apparatus further includes:
a first service module 503, configured to initiate a designated service with the first hosting network.

In an embodiment, the apparatus further includes:
a stopping module 502, configured to, in response to determining that the designated service ends, stop controlling the network selection process.

In an embodiment, the terminal device stores a hosting network list, where the hosting network list includes the first hosting network, and the hosting network list is configured to control the network selection process in response to determining that a hosting network in the hosting network list is accessed, and the apparatus further includes:
a stopping module 502, configured to, in response to determining that the designated service ends, delete the first hosting network from the hosting network list;
or the stopping module 502 is configured to, in response to determining that the designated service ends, delete the hosting network list; or
the stopping module 502 is configured to, in response to determining that the designated service ends, deactivate the hosting network list.

FIG. 6 is a structural block diagram of an apparatus for accessing a hosting network provided in an embodiment of the present disclosure. The apparatus can be implemented as a first hosting network device or as a part of a first hosting network device. The apparatus includes:
an accessing module 601, configured to provide an access service based on indication information to a terminal device, where the indication information is configured to control a network selection process of the terminal device in response to determining that the terminal device accesses a first hosting network corresponding to the first hosting network device.

In an embodiment, the indication information is configured to: in response to determining that the terminal device accesses the first hosting network and the terminal device is within a coverage area of the first hosting network, control the network selection process.

In an embodiment, the first hosting network has a corresponding valid time; and the indication information is configured to:
in response to determining that the terminal device accesses the first hosting network, and within the valid time of the first hosting network, control the network selection process; or
in response to determining that the terminal device accesses the first hosting network, within the valid time of the first hosting network, and in response to determining that the terminal device is within a coverage area of the first hosting network, control the network selection process.

In an embodiment, the indication information includes a hosting network list, where the hosting network list includes the first hosting network, and the hosting network list is configured to control the network selection process in response to determining that the terminal device accesses a hosting network in the hosting network list.

In an embodiment, the hosting network list includes a network identifier of each of at least one hosting network, and the at least one hosting network includes the first hosting network.

In an embodiment, the hosting network list is configured to:
in response to determining that the terminal device accesses the first hosting network and the hosting network list includes a network identifier of the first hosting network, control the network selection process; or
in response to determining that the terminal device accesses the first hosting network, the hosting network list includes a network identifier of the first hosting network, and the terminal device is within a coverage area of the first hosting network, control the network selection process.

In an embodiment, the hosting network list further includes at least one of: a valid time for each of the at least one hosting network, or an access technology for each of the at least one hosting network.

In an embodiment, the hosting network list is configured to:
in response to determining that the terminal device accesses the first hosting network and the hosting network list includes a network identifier of the first hosting network, and within the valid time of the first hosting network, control the network selection process; or
in response to determining that the terminal device accesses the first hosting network, the hosting network list includes a network identifier of the first hosting network, and the terminal device is within a coverage area of the first hosting network, and within the valid time of the first hosting network, control the network selection process.

In an embodiment, the indication information is configured to:
in response to determining that the terminal device accesses the first hosting network, not monitoring network signals other than a signal of the first hosting network; or
in response to determining that the terminal device accesses the first hosting network, monitoring network signals and not performing network selection.

In an embodiment, a network selection priority of the hosting network list is higher than network selection priorities of other network lists.

In an embodiment, the hosting network list is pre-configured;
the hosting network list is configured by a home network of the terminal device.

In an embodiment, the apparatus further includes:
a second service module 602 is configured to initiate a designated service with the terminal device.

FIG. 7 is a structural schematic diagram of a communication device (a terminal device or a network device) provided in an embodiment of the present disclosure. The communication device includes a processor 1001, a receiver 1002, a transmitter 1003, a memory 1004, and a bus 1005.

The processor 1001 includes one or more processing cores, the processor 1001 executes various functional applications and information processing by running software programs and modules.

The receiver 1002 and the transmitter 1003 can be implemented as a communication component, and the communication component can be a communication chip. The memory 1004 is connected to the processor 1001 through the bus 1005.

The memory 1004 can be used to store at least one instruction, and the processor 1001 is used to execute the at least one instruction to implement the various steps in the above method embodiments.

In addition, the memory 1004 can be implemented by any type of volatile or non-volatile storage device or combination thereof, including but not limited to: magnetic or optical disks, electrically erasable programmable read only memory (EEPROM), erasable programmable read only memory (EPROM), static random access memory (SRAM), read only memory (ROM), magnetic storage, flash memory, or programmable read only memory (PROM).

When the communication device is implemented as a terminal device, the processor and transceiver in the communication device involved in the embodiments of the present disclosure can perform the steps performed by the terminal device in any of the methods shown in FIGS. 2-4, which will not be repeated here.

In an embodiment, when the communication device is implemented as a terminal device,
the transceiver is used to access the first hosting network in the hosting network list, and the hosting network list is used to control the network selection process in response to determining that the hosting network in the hosting network list is accessed.

When the communication device is implemented as a network device, the processor and transceiver in the communication device involved in the embodiments of the present disclosure can perform the steps performed by the first hosting network device in any of the methods shown in FIGS. 2-4, which will not be repeated here.

In an embodiment, when the communication device is implemented as a network device,

The transceiver is configured to provide the access service based on the hosting network list to the terminal device. The hosting network list includes the first hosting network of the first hosting network device, and the hosting network list is used to control the network selection process in response to determining that the terminal device accesses the hosting network in the hosting network list.

In an embodiment, a computer-readable storage medium is further provided, which stores at least one instruction, at least one program, a code set, or an instruction set. The at least one instruction, the at least one program, the code set, or the instruction set is loaded and executed by a processor to implement the method for accessing a hosting network executed by a communication device provided by the various method embodiments described above.

In an embodiment, a chip is provided, including programmable logic circuits and/or program instructions for implementing the method for accessing a hosting network described above when the chip is run on a computer device.

In an embodiment, there is further provided a computer program product that, when run on a processor of a computer device, causes the computer device to perform the method for accessing a hosting network described above.

Those skilled in the field can understand that all or part of the steps to implement the above embodiments can be completed through hardware, or through programs that instruct relevant hardware to complete. The program can be stored in a computer-readable storage medium, such as read-only memory, magnetic disk, or optical disk.

The above embodiments provided in the present disclosure are not intended to limit the present disclosure. Any modifications, equivalent replacements, improvements, etc. made within the spirit and principles of the present disclosure shall be included in the scope of protection of the present disclosure.

1. A method for accessing a hosting network, performed by a terminal device, comprising:
in response to determining that a first hosting network is accessed, controlling a network selection process.

2. The method according to claim 1, wherein in response to determining that the first hosting network is accessed, controlling the network selection process comprises:
in response to determining that the first hosting network is accessed and the terminal device is within a coverage area of the first hosting network, controlling the network selection process.

3. The method according to claim 1, wherein the first hosting network has a valid time; and
in response to determining that the first hosting network is accessed, controlling the network selection process comprises:
in response to determining that the first hosting network is accessed, and within the valid time of the first hosting network, controlling the network selection process; or in response to determining that the first hosting network is accessed, within the valid time of the first hosting network, and in response to determining that the terminal device is within a coverage area of the first hosting network, controlling the network selection process.

4. The method according to claim 1, wherein the terminal device stores a hosting network list, wherein the hosting network list comprises the first hosting network, and the hosting network list is configured to control the network selection process in response to determining that a hosting network in the hosting network list is accessed.

5. The method according to claim 4, wherein the hosting network list comprises a network identifier of each of at least one hosting network, and the at least one hosting network comprises the first hosting network.

6. The method according to claim 5, wherein in response to determining that the first hosting network is accessed, controlling the network selection process comprises:
in response to determining that the first hosting network is accessed and the hosting network list comprises a network identifier of the first hosting network, controlling the network selection process; or
in response to determining that the first hosting network is accessed, the hosting network list comprises a network identifier of the first hosting network, and the terminal device is within a coverage area of the first hosting network, controlling the network selection process.

7-9. (canceled)

10. The method according to claim 4, wherein a network selection priority of the hosting network list is higher than network selection priorities of other network lists.

11. The method according to claim 4, wherein the hosting network list is pre-configured; or the hosting network list is configured by a home network of the terminal device.

12-15. (canceled)

16. A method for accessing a hosting network, performed by a first hosting network device, comprising:
providing an access service based on indication information to a terminal device, wherein the indication information is configured to control a network selection process of the terminal device in response to determining that the terminal device accesses a first hosting network corresponding to the first hosting network device.

17. The method according to claim 16, wherein the indication information is configured to:
in response to determining that the terminal device accesses the first hosting network and the terminal device is within a coverage area of the first hosting network, control the network selection process.

18. The method according to claim 16, wherein the first hosting network has a valid time, and the indication information is configured to:
in response to determining that the terminal device accesses the first hosting network, and within the valid time of the first hosting network, control the network selection process; or
in response to determining that the terminal device accesses the first hosting network, within the valid time of the first hosting network, and in response to determining that the terminal device is within a coverage area of the first hosting network, control the network selection process.

19. The method according to claim 16, wherein the indication information comprises a hosting network list, wherein the hosting network list comprises the first hosting network, and the hosting network list is configured to control the network selection process in response to determining that the terminal device accesses a hosting network in the hosting network list.

20. The method according to claim 19, wherein the hosting network list comprises a network identifier of each of at least one hosting network, and the at least one hosting network comprises the first hosting network.

21-24. (canceled)

25. The method according to claim 19, wherein a network selection priority of the hosting network list is higher than network selection priorities of other network lists.

26. The method according to claim 19, wherein the hosting network list is pre-configured; or the hosting network list is configured by a home network of the terminal device.

27-54. (canceled)

55. A terminal device, comprising: one or more processors; wherein the one or more processors are configured to, in response to determining that a first hosting network is accessed, control a network selection process.

56. A network device, comprising: one or more processors; wherein
the one or more processors are configured to implement the method according to claim 16.

57. A computer-readable storage medium, wherein the computer-readable storage medium stores executable instructions, and the executable instructions are loaded and executed by one or more processors to implement the method for accessing a hosting network according to claim 1.

58. A chip, comprising a programmable logic circuit or a program, wherein the chip is configured to implement the method for accessing a hosting network according to claim 1.

59. A computer program product or a computer program, comprising computer instructions stored in one or more computer-readable storage media, and one or more processors read the computer instructions from the one or more computer-readable storage media and execute the computer instructions to implement the method for accessing a hosting network according to claim 1.
